(19) United States
(12) Patent Application Publication
(10) Pub. No.: US 2002/0129652 A1
(43) Pub. Date: Sep. 19, 2002

(54) Angular rate sensor

(76) Inventors: Robert Aigner, Munchen (DE); Martin Handtmann, Munchen (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/122,625

(22) Filed: Apr. 15, 2002

Related U.S. Application Data
(63) Continuation of application No. PCT/EP00/10110, filed on Oct. 13, 2000.

(30) Foreign Application Priority Data
Oct. 14, 1999 (DE) 199 49 611.0

(51) Int. Cl. G01P 15/00

(52) U.S. Cl. 73/514.16

(57) ABSTRACT

An angular rate sensor includes a ring that is kept floating by electrostatic forces between electrodes without the ring being mechanically or electrically contacted. The ring is divided into segments of differing radial dimensions which cooperate with a multi-phase drive from segmented electrodes to exert a torque on the floating ring which causes the ring to rotate. A control of the position of the ring and a detection of the Coriolis force that occurs are achieved by the voltages applied to the electrodes.

### CROSS-REFERENCE TO RELATED APPLICATION

This application is a continuation of copending International Application No. PCT/EP00/10110, filed Oct. 13, 2000, which designated the United States.

### BACKGROUND OF THE INVENTION

### Field of the Invention

The invention relates to an angular rate sensor that can be produced micromechanically.

Angular rate sensors (gyroscopes) measure the rotational speed of a system about an unknown axis by detecting the Coriolis force. International Publication No. WO98/23917 describes an angular rate sensor as a micromechanical component, in which a ring with a rigid web along a diameter is suspended by resilient struts and anchors on a substrate in such a way that it can execute rotational oscillations about its mid-axis and, under the action of external torques, can be tilted about the web. On the ring and on the substrate there are electrodes, to which electrical voltages can be applied in such a way that rotational oscillations of the ring about its mid-axis can be excited and rotational oscillations about the web can be detected.

Conventional angular rate sensors that can be produced micromechanically are based on resonant structures, since completely rotating structures such as those in the gyroscopic compass, for example, cause considerable technical difficulties during production and, in particular, in the mounting of a rotating element. The detection limit in degrees of angle per second which can be achieved is determined by technological fluctuations during production and by fundamental physical limits. A further disadvantage of the resonant structures is that an interfering oscillatory coupling occurs between the drive and the detection oscillation. The error signals brought about as a result, which are known as quadrature errors, interfere with the zero-point stability of an angular rate sensor to a considerable extent. This difficulty could be eliminated only by a considerable increase in the signal amplitude.

### SUMMARY OF THE INVENTION

It is accordingly an object of the invention to provide an angular rate sensor which overcomes the above-mentioned disadvantages of the heretofore-known angular rate sensors of this general type and which can be produced micromechanically and with which the problems of sensors which are operated with a resonance are eliminated.

With the foregoing and other objects in view there is provided, in accordance with the invention, an angular rate sensor, including:

a disk-shaped or ring-shaped rotational element, the rotational element having circularly disposed segments and having a given electrical conductivity;

at least two layers including electrodes, the electrodes being disposed circularly and being oriented horizontally, the electrodes having electrical connections;

the rotational element having no dedicated electrical connection and being disposed between the electrodes;

the rotational element being disposed with respect to the electrodes such that the segments of the rotational element and the electrodes overlap one another in dependence of a rotational position of the rotational element; and

the rotational element being set into a rotary motion and kept floating by electric potentials applied to the electrodes.

In other words, an angular rate sensor sensor having an electrically adequately conductive, disk-like or ring-like rotational element, which has segments arranged in a circle, and having at least two layers of electrodes which are arranged in a circle in horizontal alignment and provided with electrical connections and between which the rotational element is arranged without having its own electrical connection, is characterized in that the rotational element is arranged in such a manner with respect to the electrodes that the segments of the rotational element and the electrodes overlap one another, depending on the rotational position of the rotational element, and in that the rotational element is both set rotating and kept floating by electric potentials applied to the electrodes.

In the angular rate sensor according to the invention, a disk-like or ring-like rotational element, preferably a polysilicon ring, is kept floating without mechanical or electrical contact in a special configuration of electrodes through the use of electrostatic forces, and set rotating in a floating manner. By structuring the rotational element in segments with different radial dimensions and a suitable multi-phase driving through the use of segmented electrodes, a torque is exerted on the floating rotational element, which causes the rotation. The control of the position of the rotational element and the detection of a Coriolis force that occurs are preferably likewise carried out through the use of the segmented electrodes. The Coriolis force and the sensor signal caused by it then can be increased to an extreme extent by increasing the rotational speed of the rotational element, so that the angular rate sensor has a considerable sensitivity. A significant advantage of the angular rate sensor according to the invention is that interfering modes of the oscillation lie with their frequency far outside the frequency bandwidth of the sensor signals, and do not have the effect of any degradation of the zero-point stability.

With the objects of the invention in view there is also provided, an angular rate sensor, including:

a ring-shaped rotational element having a given electrical conductivity;

at least two layers including electrodes, the electrodes being oriented horizontally and having electrical connections;

the ring-shaped rotational element having no dedicated electrode and being disposed between the electrodes; and

the ring-shaped rotational element being disposed with respect to the electrodes such that the ring-shaped rotational element is set into a rotary motion and kept floating by electric potentials applied to the electrodes.

In other words, an angular rate sensor having an electrically adequately conductive rotational element and having at least two layers of electrodes which are arranged in horizontal alignment and provided with electrical connections and between which the rotational element is arranged without having its own electrical connection, the rotational element being arranged in such a way with respect to the electrodes that it is set rotating and kept floating by electric potentials applied to the electrodes, and wherein the rotational element is formed like a ring.

According to another feature of the invention, the rotational element has a rotational symmetry with respect to an angle of 120°.

According to yet another feature of the invention, the ring-shaped rotational element has segments with respective different radial dimensions.

According to another feature of the invention, each of the at least two layers of electrodes is provided in two circular rings divided in ring segments and disposed concentrically with respect to one another; and each of the electrodes is provided in a respective one of the ring segments of a respective one of the two circular rings.

According to a further feature of the invention, the ring-shaped rotational element has segments with respective different radial dimensions.

According to another feature of the invention, the ring-shaped rotational element has segments having cut-outs formed therein.

Other features which are considered as characteristic for the invention are set forth in the appended claims.

Although the invention is illustrated and described herein as embodied in an angular rate sensor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIGS. 1, 3 and 4 are diagrammatic plan views of exemplary embodiments of the configuration of the electrodes;

FIGS. 2 and 6 are diagrammatic plan views of two exemplary embodiments of the rotational element;

FIG. 5 is a schematically simplified cross sectional view of an angular rate sensor; and

FIGS. 7 to 9 are diagrammatic side views of three different positions of a rotational element between the electrodes, in order to explain the drive principle.

### DESCRIPTION OF THE PREFERRED EMBODIMENTS

In order to keep an electrically adequately conductive plate floating between capacitor plates which are aligned horizontally and provided vertically one above the other, without any dedicated electrical connection, at least two mutually insulated capacitor plates are required above the plate to be held floating, between which plates a suitable electric potential difference is applied. If, underneath the plate, there are likewise two capacitor plates with a potential difference applied between them, the force exerted by the upper capacitor plates on the plate and directed upward (because it is always an attracting force) is to a certain extent compensated by a force which is directed downward and is exerted on the plate by the lower capacitor plates. Given suitable selection and readjustment of the potential differences, the plate can be kept floating within close limits.

A simple model, which does not take into account tilting of the held plate, is intended to clarify the fact that, in principle, the required voltages can be determined by calculation as a function of the relevant physical and geometric variables, without requiring any further inventive step. If the number of upper capacitor plates is equal to the number of lower capacitor plates and all capacitor plates have the same area, the electric potential of the floating plate is:

Uₚ=[(d/2−z) (U₁₁+U₁₂+. . . U₁ₙ)+(d/2+z) (U₂₁+U₂₂+. . . +U₂ₙ)+Q(d²/4−z²)/(Aε₀)]/(nd)

where:

d is the air gap between the capacitor plates,

z is the distance of the plate from its central position between the capacitor plates in the upward direction,

U₁ᵢ is the electric potential applied to the ith lower capacitor plate,

U₂ᵢ is the electric potential applied to the ith upper capacitor plate,

Q is the electric charge present on the plate,

A is the area of a capacitor plate,

ε₀ is the electric field constant (absolute dielectric constant) and

n is the number of upper and lower capacitor plates.

Here, the thickness of the floating plate has been ignored.

The force exerted on the floating plate by the ith lower capacitor plate is then:

F₁ᵢ=(U₁ᵢ−Uₚ)²·Aε₀/(d/2+z)²

the force exerted on the floating plate by the ith upper capacitor plate is correspondingly:

F₂ᵢ=(U₂ᵢ−Uₚ)²·Aε₀/(d/2+z)²

the resulting overall force upward acting on the plate is equal to the sum of all F₂ᵢ reduced by the sum of all F₁ᵢ.

In order to be able to prevent tilting of the floating plate, the angular rate sensor according to the invention has, at the top and bottom in each case, at least three electrodes functioning as capacitor plates.

The always attracting electrostatic forces pull a floating plate into the interior of the capacitor formed by the electrodes, so that the area in which the plate and the electrodes overlap in the vertical direction of view is always the greatest. This is the basis for the drive with which the rotational element is set rotating. The rotational element is configured in such a way that it has different radial dimensions in successive segments. As a result, during a rotational movement of the rotational element, the area of the overlap with a specific pair of electrodes varies. Driving the electrodes cyclically and with subdivision into phases, using applied potentials, makes it possible to exert an attractive force on the rotational element in each case in the direction of the same direction of rotation and in this way to generate a rotational movement.

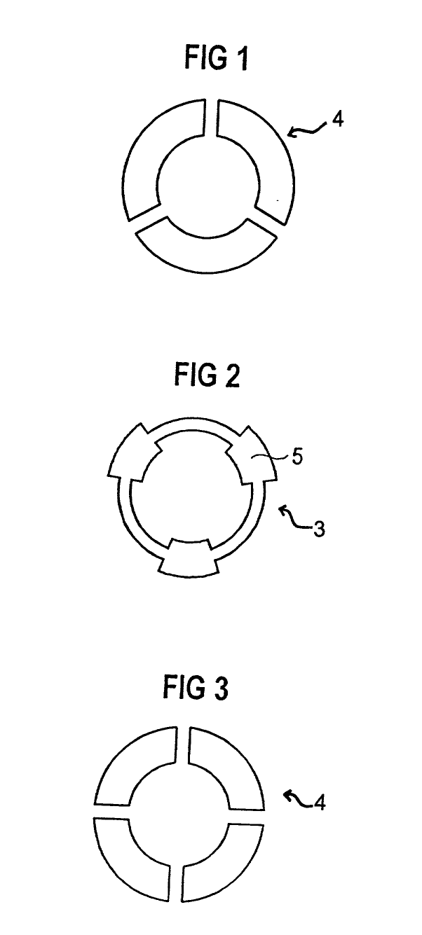

FIG. 1 shows in plan view the configuration of three electrodes in three circular ring sectors located rotationally symmetrically in relation to a 120° angle.

FIG. 2 shows a matching form of the rotational element in plan view. The rotational element here is a ring having three broadenings or broadened segments 5 provided rotationally symmetrically in relation to a 120° angle. These broadenings or broadened segments are formed by the radial dimensions in three segments of the ring differing from the remaining width of the ring. These broadenings are used to drive the ring through the use of electrodes fitted above and below and having a form as illustrated in plan view in FIG. 1.

FIG. 3 shows an alternative configuration of the electrodes with a subdivision into four segments. For reasons of optimizing the drive, however, triple symmetries are preferred, in which the smallest angle of the rotational symmetry is an integer fraction of 360° which can be divided by three (120° [÷3], 60° [÷], 40° [÷9], 30° [÷12], 24° [÷15], 20° [÷18]).

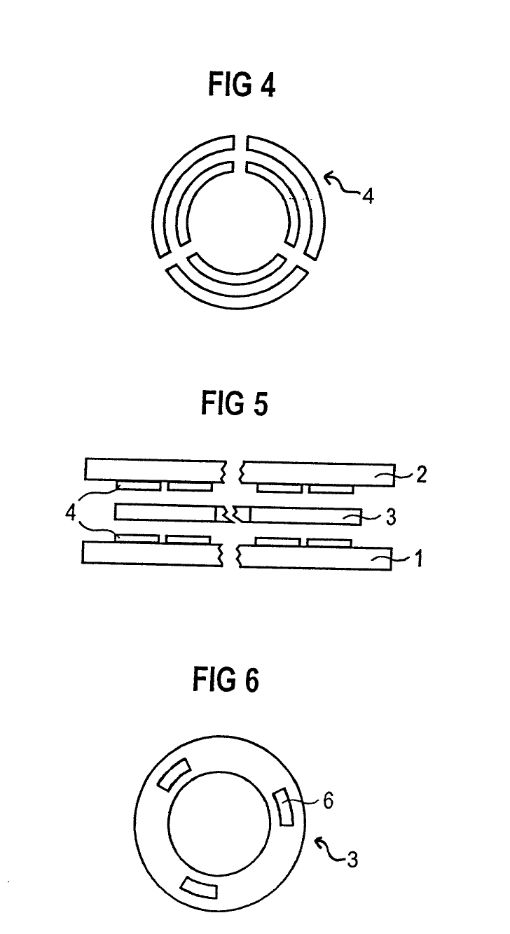

In order to ensure the centring of the floating rotational element, it is advantageous if the electrodes are divided up into two concentric circular rings, as illustrated in plan view in FIG. 4. An annular rotational element can be pulled into a position concentric with the electrodes through the use of mutually different electric potentials on the inner and the outer electrodes. This stabilizes the position of the axis of rotation.

FIG. 5 shows a schematically simplified cross section of an angular rate sensor. The rotational element 3 is kept floating between the electrodes 4. The electrodes 4 are fitted to a substrate 1 or a semiconductor chip and to a cover 2 or a second substrate, which is connected to the first, for example through the use of wafer bonding.

FIG. 6 shows an alternative configuration of an annular rotational element in plan view. Here, the different configuration in individual segments is not formed by a broadening of the ring but by cut-outs 6 in the ring, of which three are shown as an example in FIG. 6. This configuration has the advantage that, because of the greater annular area as compared with the exemplary embodiment according to FIG. 2, and therefore the greater area of the overlap with the electrodes, better stabilization of the position of the rotational element is possible. Furthermore, the broader ring is mechanically more stable and has a greater moment of inertia.

As soon as a cut-out 6 in the rotational element 3 begins to overlap with an electrode 4 in the vertical direction of view, the potential applied to this electrode is switched to the potential on the rotational element or to float. This means that the area of the overlap of cut-out and electrode can be enlarged without any restoring force occurring. The electrodes adjacent to the relevant cut-out have a high potential difference applied to them, in order to produce a torque acting on the rotational element.

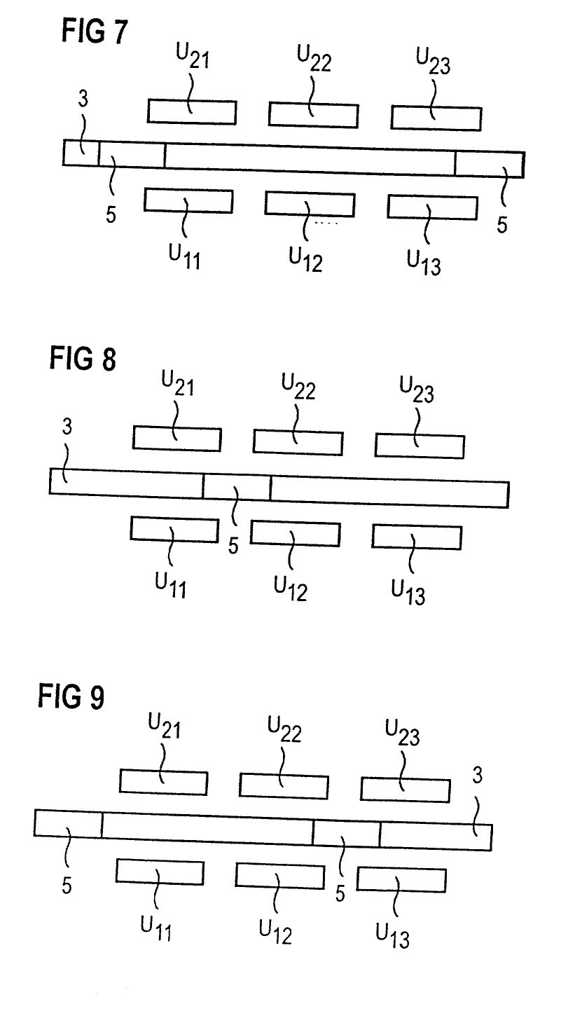

FIGS. 7 to 9 explain the drive principle. For this purpose, in a side view in each case three lower electrodes U₁₁, U₁₂, U₁₃ and three upper electrodes U₂₁, U₂₂, U₂₃ are shown, between which a ring-like rotational element 3 provided with broadenings 5 is provided. Let the illustrated edge of the rotational element move to the right in this example, so that the broadening 5 of the rotational element 3 shown on the left-hand side in FIG. 7 comes firstly between the electrodes U₁₁ and U₂₁, then between the electrodes U₁₂ and U₂₂ and then between the electrodes U₁₃ and U₂₃ in the course of the rotation, while the broadening 5 shown on the right-hand side disappears behind the plane of the drawing and moves to the left at the rear.

The electrodes between which a broadening 5 of the rotational element is currently pulled are set to the potential Uₚ of the rotational element, while potential differences are applied to the pairs of electrodes in front and behind it. In the illustrated example, for the configuration in FIG. 7, the result is the following relations between the potentials:

U₁₁=U₂₁=Uₚ, U₁₂>Uₚ, U₁₃<Uₚ, U₂₂>Uₚ, U₂₃<Uₚ;

for the configuration in FIG. 8:

U₁₂=U₂₂=Uₚ, U₁₁>Uₚ, U₁₃<Uₚ, U₂₁>Uₚ, U₂₃<Uₚ; and

for the configuration in FIG. 9:

U₁₃=U₂₃=Uₚ, U₁₁>Uₚ, U₁₂<Uₚ, U₂₁>Uₚ, U₂₂<Uₚ.

A Coriolis force which occurs is detected by evaluating the electrical voltages which have to be applied to the electrodes in order to keep the rotational element in its plane of rotation. As long as the angular rate sensor remains aligned horizontally, the compensation of gravitation and rectilinear accelerations requires equally large electrostatic forces at all electrode positions. A Coriolis force arising from tilting of the angular rate sensor appears as a torque which can be compensated only through the use of forces of different magnitudes and therefore only through the use of different potentials on the electrodes. The required potential differences can be determined, and the magnitude of the Coriolis force can be determined from these. One advantage as compared with resonant structures is that in this case no effects of the suspension of the rotational element on the resonant frequencies of the drive and the Coriolis oscillation need to be taken into account.

We claim:

1. An angular rate sensor, comprising:
a rotational element selected from the group consisting of a disk-shaped rotational element and a ring-shaped rotational element, said rotational element having circularly disposed segments and having a given electrical conductivity;
at least two layers including electrodes, said electrodes being disposed circularly and being oriented horizontally, said electrodes having electrical connections;
said rotational element having no dedicated electrical connection and being disposed between said electrodes;
said rotational element being disposed with respect to said electrodes such that said segments of said rotational element and said electrodes overlap one another in dependence of a rotational position of said rotational element; and
said rotational element being set into a rotary motion and kept floating by electric potentials applied to said electrodes.

2. The angular rate sensor according to claim 1, wherein said rotational element has a rotational symmetry with respect to an angle of 120°.

3. The angular rate sensor according to claim 1, wherein:
said rotational element is said ring-shaped rotational element; and
said segments have respective different radial dimensions.

4. The angular rate sensor according to claim 1, wherein:
each of said at least two layers including said electrodes is provided in two circular rings divided in ring segments and disposed concentrically with respect to one another; and
each of said electrodes is provided in a respective one of the ring segments of a respective one of the two circular rings.

5. An angular rate sensor, comprising:
a ring-shaped rotational element having a given electrical conductivity;
at least two layers including electrodes, said electrodes being oriented horizontally and having electrical connections;
said ring-shaped rotational element having no dedicated electrode and being disposed between said electrodes; and
said ring-shaped rotational element being disposed with respect to said electrodes such that said ring-shaped rotational element is set into a rotary motion and kept floating by electric potentials applied to said electrodes.

6. The angular rate sensor according to claim 5, wherein said ring-shaped rotational element has segments with respective different radial dimensions.

7. The angular rate sensor according to claim 5, wherein said ring-shaped rotational element has segments having cut-outs formed therein.

8. The angular rate sensor according to claim 5, wherein:
each of said at least two layers including said electrodes is provided in two circular rings divided in ring segments and disposed concentrically with respect to one another; and
each of said electrodes is provided in a respective one of the ring segments of a respective one of the two circular rings.
